(19) United States
(12) Patent Application Publication
(10) Pub. No.: US 2021/0145216 A1
(43) Pub. Date: May 20, 2021

(54) Beaters for Mixer with Blades with Continuous Surfaces

(71) Applicant: Hamilton Beach Brands, Inc., Glen Allen, VA (US)

(72) Inventors: Michael Garman, Stafford, VA (US); Ashley M. Anderson-Shead, Henrico, VA (US); Koen Aidan Ambrose, Glen Allen, VA (US)

(21) Appl. No.: 17/097,538

(22) Filed: Nov. 13, 2020

Related U.S. Application Data
(60) Provisional application No. 62/936,851, filed on Nov. 18, 2019.

(51) Int. Cl. A47J 43/07

(52) U.S. Cl. CPC A47J 43/0711

(57) ABSTRACT

A mixer includes: a housing containing a motor and first and second beater mounting locations; and first and second beaters. Each of the first and second beaters comprises: an elongate shaft that defines a longitudinal axis between first and second ends; and a blade complex including a central body and at least three blades, the central body attached to the first end of the shaft, the blades attached to and extending radially outwardly from the shaft, each of the blades including a partially helical radially-outward edge, each blade including a continuous surface devoid of openings between the body and the radially-outward edge.

### FIELD OF THE INVENTION

The invention described herein relates to beater and mixer blades.

### BACKGROUND

Hand mixers typically include a pair of beaters, each of which rotates about a shaft mounted to the housing of the mixer. The beaters include open, skeletal blades that may mimic a wire whisk. The beaters should be designed to withstand the rigors of mixing a variety of foodstuffs, from relatively watery substances such as soups and salad dressings to far more viscous mixtures such as cake batters or cookie or bread doughs. Exemplary mixer beaters are shown in U.S. Pat. No. 8,746,957 and U.S. Design Pat. No. D818,762, each of which is incorporated herein by reference in full.

One potential issue that may arise with typical beaters involves cleaning them after use. A significant volume of empty space is present within the skeletal framework of each blade. The material being mixed may cling to the surfaces of the beater after use, which may include inner surfaces of the blades. This foodstuff inside the beater also does not get properly mixed with the remaining foodstuff. These surfaces may be difficult to clean, particularly if the material is somewhat sticky. Further, the efficacy of the mixing action might be improved via a new beater construction.

### SUMMARY

As a first aspect, embodiments of the invention are directed to a beater for a mixer comprising: an elongate shaft that defines a longitudinal axis between first and second ends; and a blade complex including a central body and at least three blades. The central body is attached to the first end of the shaft. The blades are attached to and extend radially outwardly from the shaft. Each of the blades includes a partially helical radially-outward edge. Each blade also includes a continuous surface devoid of openings between the body and the edge, the surface including a concave section.

As a second aspect, embodiments of the invention are directed to a mixer comprising: a housing containing a motor and first and second beater mounting locations; and first and second beaters. Each of the first and second beaters comprises: an elongate shaft that defines a longitudinal axis between first and second ends; and a blade complex including a central body and at least three blades, the central body attached to the first end of the shaft, the blades attached to and extending radially outwardly from the shaft, each of the blades including a partially helical radially-outward edge, each blade including a continuous surface devoid of openings between the body and the radially-outward edge. The blade complex of the first beater is a mirror image of the blade complex of the second beater.

As a third aspect, embodiments of the invention are directed to a mixer comprising: a housing containing a motor and first and second beater mounting locations; and first and second beaters. Each of the first and second beaters comprises: an elongate shaft that defines a longitudinal axis between first and second ends; and a blade complex including a central body and at least three blades, the central body attached to the first end of the shaft, the blades attached to and extending radially outwardly from the shaft, each of the blades including a partially helical radially-outward edge, each blade including a continuous surface devoid of openings between the body and the radially-outward edge. Each of the first and second beaters includes a registration feature mounted to the shaft that is configured to allow each of the first and second beaters to be mounted to a respective one of the first and second mounting locations on the housing in one of only three orientations relative to the longitudinal axis.

### BRIEF DESCRIPTION OF THE FIGURES

FIG. 1 is a perspective view of a hand mixer according to embodiments of the invention.

FIG. 2 is a perspective view of one of the beaters of the mixer of FIG. 1.

FIG. 3 is a top view of the beater of FIG. 2.

FIG. 4 is a bottom view of the beater of FIG. 2.

FIG. 5 is a front view of the beater of FIG. 2.

FIG. 6 is a rear view of the beater of FIG. 2.

FIG. 7 is a right side view of the beater of FIG. 2.

FIG. 8 is a left side view of the beater of FIG. 2.

FIG. 9 is a section view of the blades of the beater of FIG. 2 taken along line 9-9 of FIG. 5.

FIG. 10 is a section view of the blades of the beater of FIG. 4 taken along line 10-10 of FIG. 5.

FIG. 11 is a perspective view of two beaters of the hand mixer of FIG. 1.

FIG. 12 is a top view of the beaters of FIG. 11.

FIG. 13 is a bottom view of the blades of the beater of FIG. 11.

FIG. 14 is an enlarged partial perspective view of another embodiment of a pair of beaters in which the registry block has three radially-extending spokes, wherein the shaft includes a groove that receives a detent to maintain the beater in place.

FIG. 15 is an enlarged side view of the upper end of the shaft of one of the beaters of FIG. 14.

FIG. 16 is an enlarged, partial perspective view of a further embodiment of a beater in which the registry block has three radially-extending spokes, wherein the upper end of the registry block includes a groove that receives a detent to maintain the beater in place.

FIG. 17 is an enlarged side view of the upper end of the registry block of the beater of FIG. 16.

FIG. 18 is an enlarged, partial perspective view of a further embodiment of a beater in which the registry block has three radially-extending spokes, wherein a sleeve mounted above the upper end of the registry block includes a groove that receives a detent to maintain the beater in place.

FIG. 19 is an enlarged side view of the upper end of the registry block of the beater of FIG. 18.

FIG. 20 is a perspective view of two beaters with four blades each that may be employed with a mixer according to embodiments of the invention.

FIG. 21 is a side view of one of the beaters of FIG. 20.

FIG. 22 is an additional side view of FIG. 21.

FIG. 23 is a front view of the beater of FIG. 21.

FIG. 24 is a rear view of the beater of FIG. 21.

FIG. 25 is a top view of the beater of FIG. 21.

FIG. 26 is a bottom view of the beater of FIG. 21.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

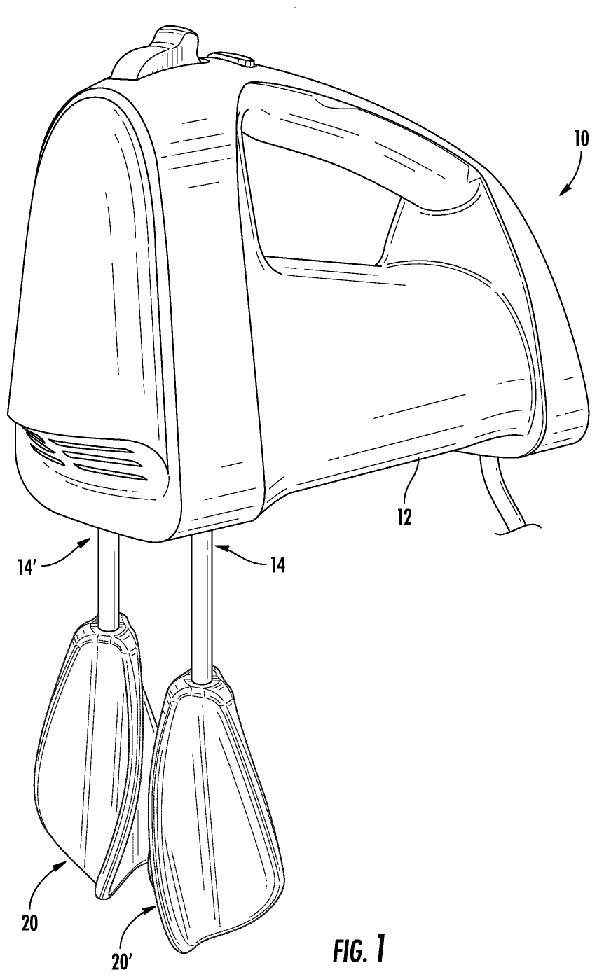

Referring now to the drawings, a hand mixer, designated broadly at 10, is illustrated in FIG. 1. The mixer 10 includes a housing 12 to which two beaters 20, 20′ are mounted in mounting locations 14, 14′. Within and on the housing 12, the mixer 10 includes components for the power and operation thereof, such as a motor, a power cord, a drive train, electronics to control operation, and actuation buttons, levers, and the like. These components may be of conventional construction and need not be described in detail herein.

As can be seen in FIG. 1, the beaters 20, 20′ are mounted to a lower surface of the front portion of the housing 10. With one exception (explained below), the beaters 20, 20′ are mirror images of each other. As such, only the beater 20 will be described in detail herein, with the understanding that the description is equally applicable to the beater 20′.

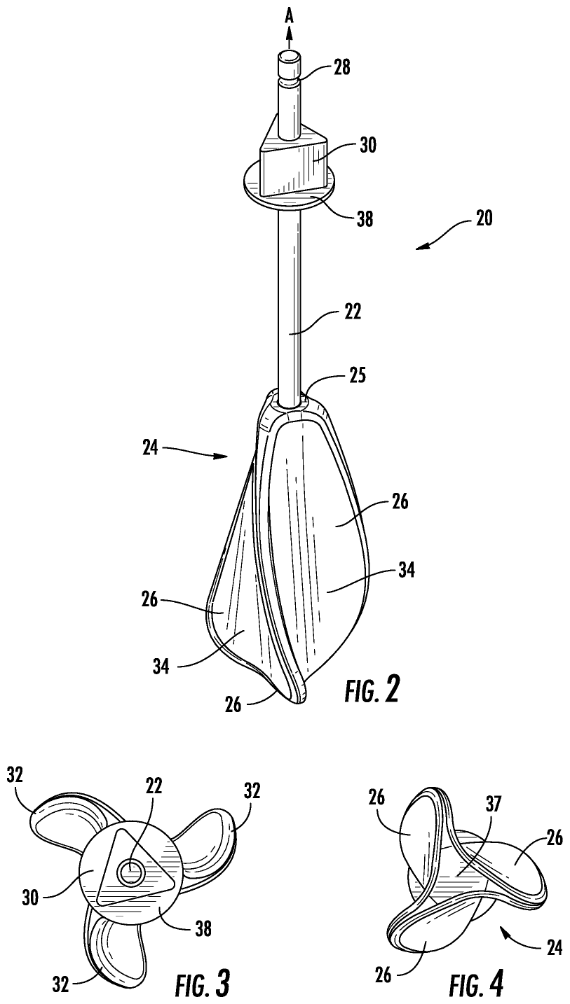

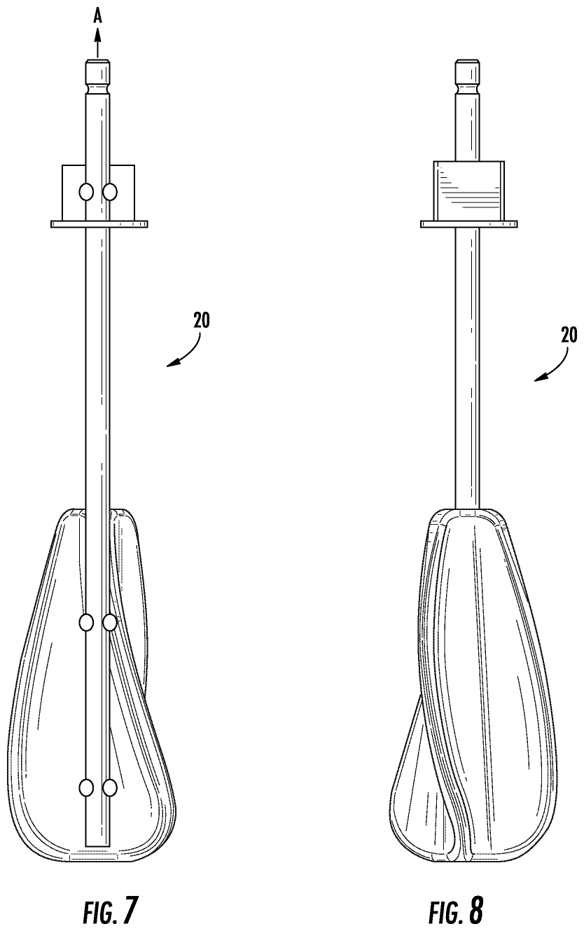

Referring now to FIGS. 2-10, the beater 20 includes a shaft 22 and a blade complex 24 comprising three blades 26. The shaft 22 is elongate and defines a longitudinal axis A. At its upper end, the shaft 22 has a circumferential groove 28. A triangular registry block 30 is fixed to the shaft 22 below the groove 28. The beater 20 also has a circular washer 38 that is mounted to the shaft 22 adjacent and beneath the registry block 30.

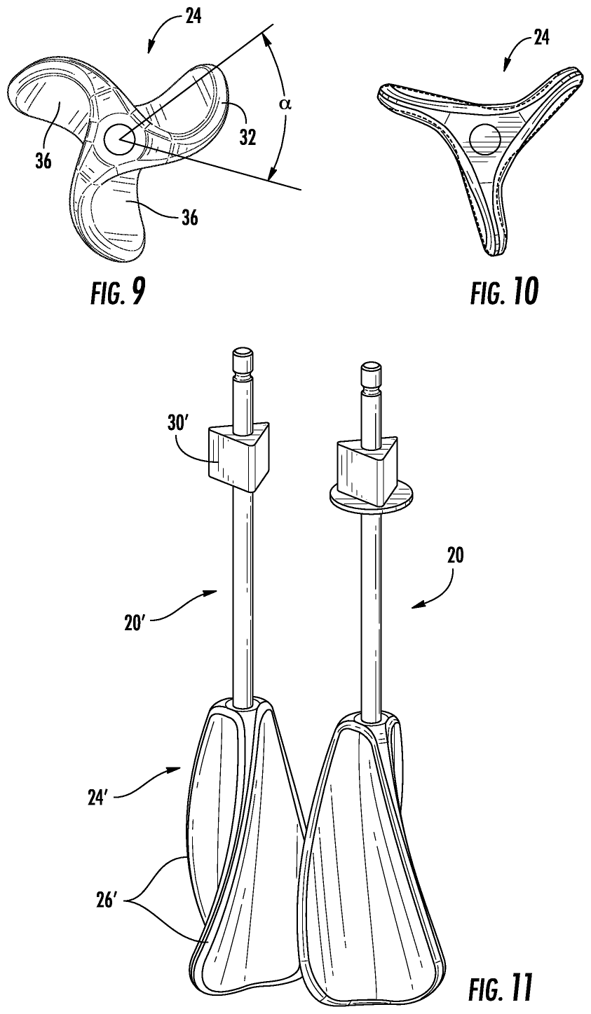

The blade complex 24 is mounted to the lower end of the shaft 22 for rotation with the shaft 22. The blade complex 24 includes a central body 25 that surrounds the shaft 22. Each of the blades 26 extends radially outwardly from the body 25. Each blade 26 is twisted about the axis A defined by the shaft 22 (FIG. 2), such that the outer edge 32 of each blade 26 defines a portion of a helix as it extends along the length of the shaft 22. The arc length of twist α is typically between about 30 and 75 degrees, with an arc length α of about 60 degrees in some embodiments (see FIG. 9). In additional embodiments, say with four or more blades, the arc length α would be less than 30 in the range of 15-30 degrees. In addition, the edges 32 of the blades 26 gradually widen or taper outwardly for a major portion of the distance between the upper edge of the body 25 and the lower end of the shaft 22. Further, each edge 32 is configured such that, with increasing distance from its upper end, a line tangent to the edge 32 defines an angle with the longitudinal axis A that increases (in other words, the edge 32 becomes less vertical as it runs from its upper to its lower end).

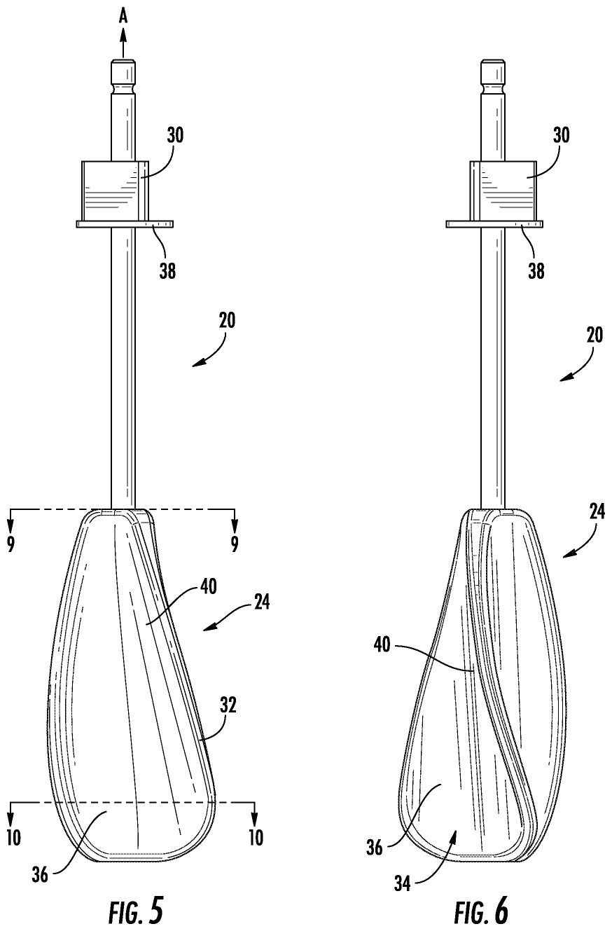

The blades 26 are positioned circumferentially equidistant about the body 25 (i.e., approximately 120 degrees apart). Notably, each of the blades 26 is continuous and unbroken from the body 25 to its edge 32, with no voids or openings. As such, between adjacent blades 26 continuous, unbroken surfaces 34 are formed. Each of the continuous surfaces 34 includes a prominent concave section 36 and a smaller convex section 40 (see FIGS. 5 and 6). A non-concave (often flat) lower surface 37 of the body 25 is also present (FIG. 4). The surfaces 34 are non-uniformly smooth.

In the illustrated embodiment, the blade complex 24 is formed as a monolithic component, although in other embodiments the blades 26 may be formed individually. The blade complex 24 may be formed of any material, but typically is formed of a polymeric material, such as POM (polyoxymethylene). In some embodiments, the blade complex 24 may be formed of or coated with a “non-stick” or “low-stick” material, such as polytetrafluroethylene (PTFE, also known as TEFLON).

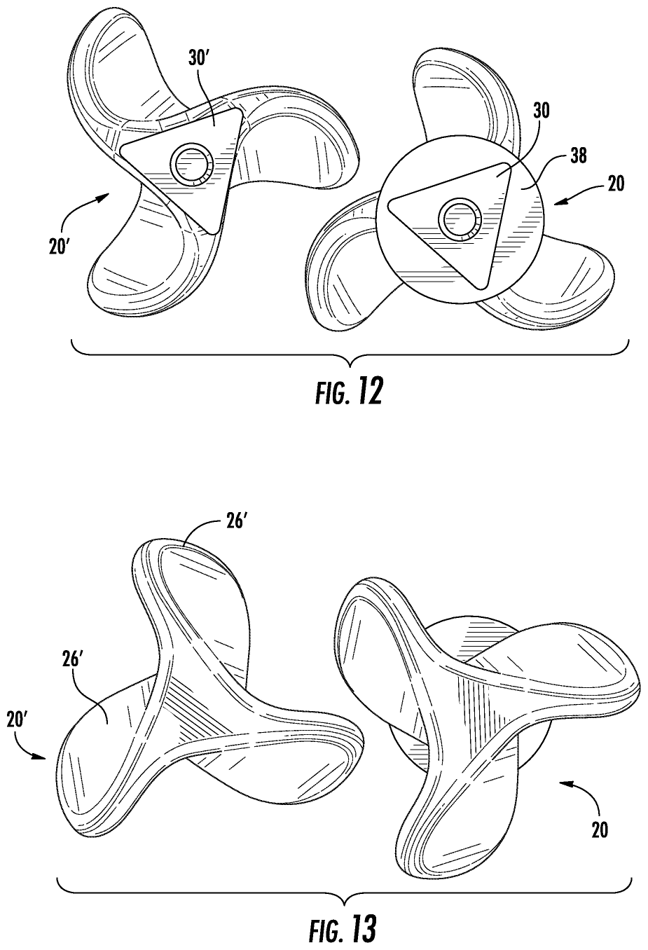

As noted above, the beater 20′ (FIGS. 11-13) is largely a mirror image of the beater 20: it has a shaft 22′ with a triangular registry block 30′ and a beater complex 24′ that has three blades 26′, each of which has an edge 32′ that follows a helical path that is the inverse of one of the blades 26 of the beater 20. The beater 20′ lacks a circular washer 38 beneath the registry block 30′.

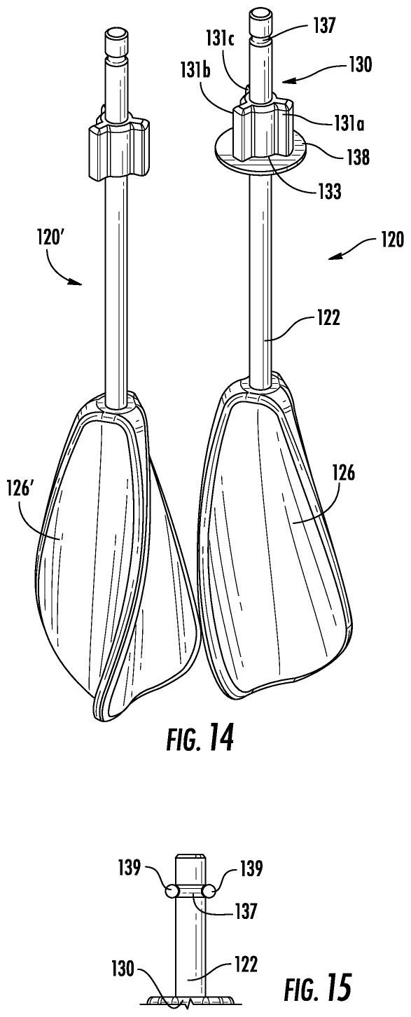

In operation, the beaters 20, 20′ are mounted in the housing 12 in the mounting locations 14. Each of the mounting locations 14, 14′ is configured so that it can accept only one of the beaters 20, 20′: the mounting location 14′ has no recess to enable it to receive the washer 38 of the beater 20, and thus can only accept the beater 20′. Also, the mounting locations 14, 14′ are configured to receive the triangular registry blocks 30, 30′. The registry blocks 30, 30′ enable each of the beaters 20, 20′ to be mounted in the mounting locations 14, 14′ in one of only three orientations relative to the longitudinal axis A, each of which is spaced 120 degrees from the others. Also, the mounting location 14′ is configured so that, when the beaters 20, 20′ are mounted, the blades 26′ are rotated 60 degrees from the blades 26. This orientation enables the blades 26, 26′ to mesh or interleave as the beaters 20, 20′ rotate about their respective longitudinal axes without interfering with each other (see FIGS. 12 and 13); typically, the drive train is configured so that the beaters 20, 20′ rotate in opposite rotative directions from each other. In addition, the mirror image configuration of the beaters 20, 20′ can help to draw the matter being mixed toward the center of the bowl, particularly when the edge of each blade 26, 26′ “leads” the remainder of the blade 24, 24′ during rotation.

After the mixer 10 has been used, the beaters 20, 20′ are typically removed from the housing 12 for cleaning. The continuous nature of the surfaces 34 can significantly facilitate wiping and cleaning of the beaters 20, 20′. As there are no holes or openings in the blades 26 or surfaces 34, there is no small recess or hole in which leftover foodstuff might reside or cling to. As a result, cleaning of the beaters 20, 20′ can occur more quickly and/or can be more thorough. Cleaning can be facilitated for virtually any foodstuff, whether it be a relatively watery mixture such as a soup, salad dressing, gravy, sauce or the like, or a higher viscosity mixture, such as a cake, pancake or waffle batter, cookie or bread dough, pie crust batter, or the like.

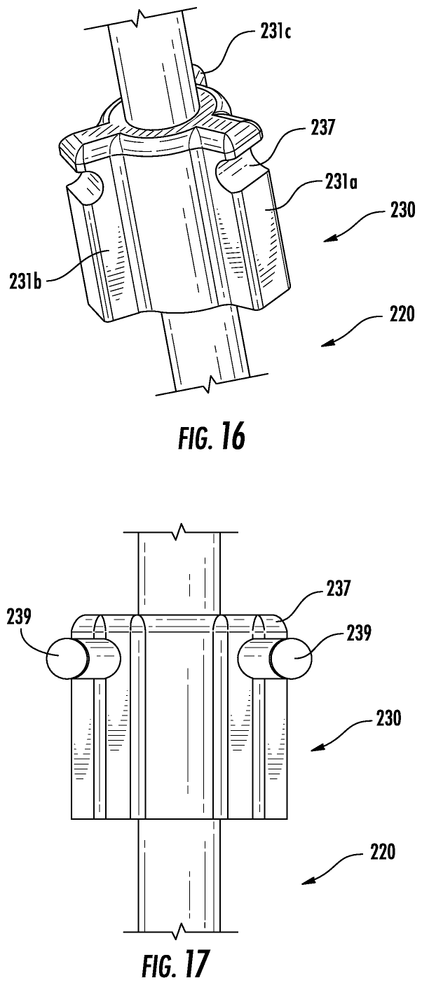

Those of skill in this art will appreciate that the mixer 10 may take other forms. For example, As another example, the registry blocks 30, 30′ are shown as being triangular, but a registry feature may take another shape (such as three spokes or similar circumferentially equidistant projections emanating from a central hub) that enables the beaters 20, 20′ to be mounted in one of only three possible orientations. Referring now to FIGS. 14 and 15, each of the beaters 120, 120′ illustrated therein has a registry block 130 that includes three spokes 131a, 131b, 131c extending radially outwardly from a central hub 133. The presence of the three spokes 131a-c can orient the beaters 120, 120′ correctly on the mixer 10 so that the blades 126, 126′ are properly positioned relative to each other. The beater 120 also has a washer 138 to distinguish it from the beater 120′ to ensure that the correct beater 120, 120′ is mounted in the correct mounting location on the mixer 10.

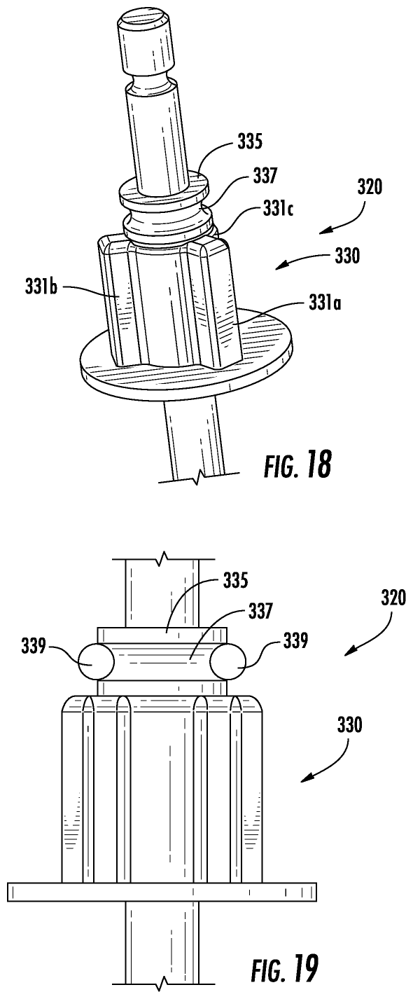

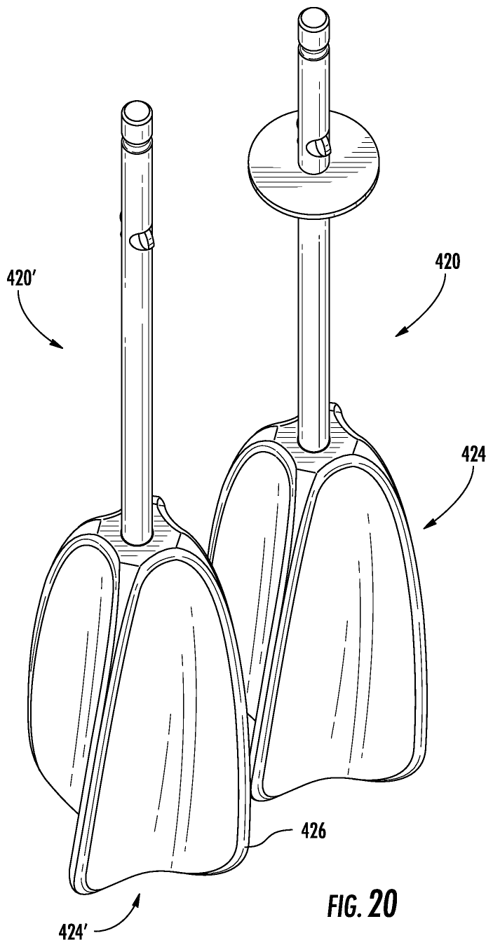

Each of the beaters 120, 120′ also includes a groove 137 near the upper end of the shaft 122. The groove 137 is present to receive a detent 139 presented by the mounting location 14 to secure the beater 120, 120′ in place. The detent 139 may take many forms, but as an example may be a spring loaded ball bearing, pin or the like. Alternative embodiments are shown in FIGS. 16 and 17, wherein a beater 220 with a registry block 230 having spokes 231a-231c includes a groove 237 in the spokes 231a-231c for receiving a detent 239, and in FIGS. 18 and 19, wherein a beater 320 with a registry block 330 having spokes 331a-331c includes a sleeve 335 with a groove 337 for receiving a detent 339.

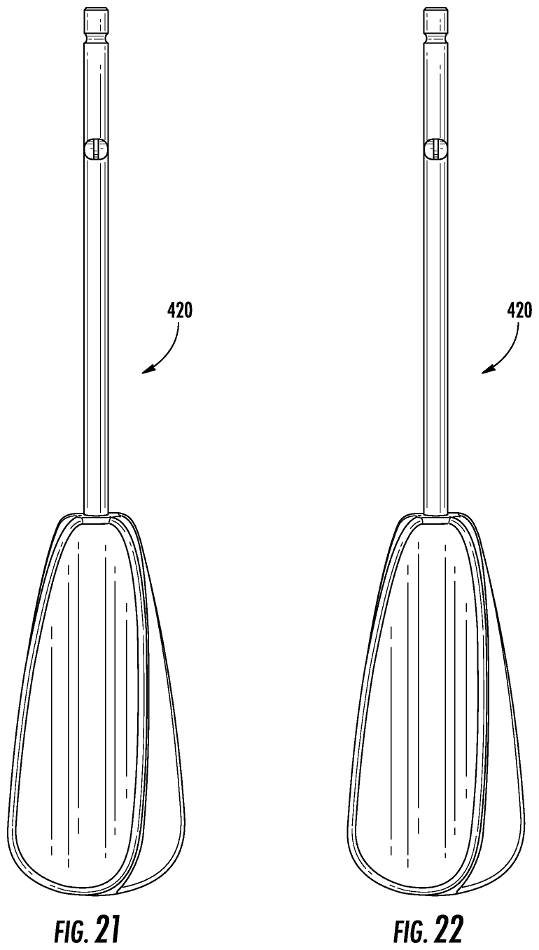

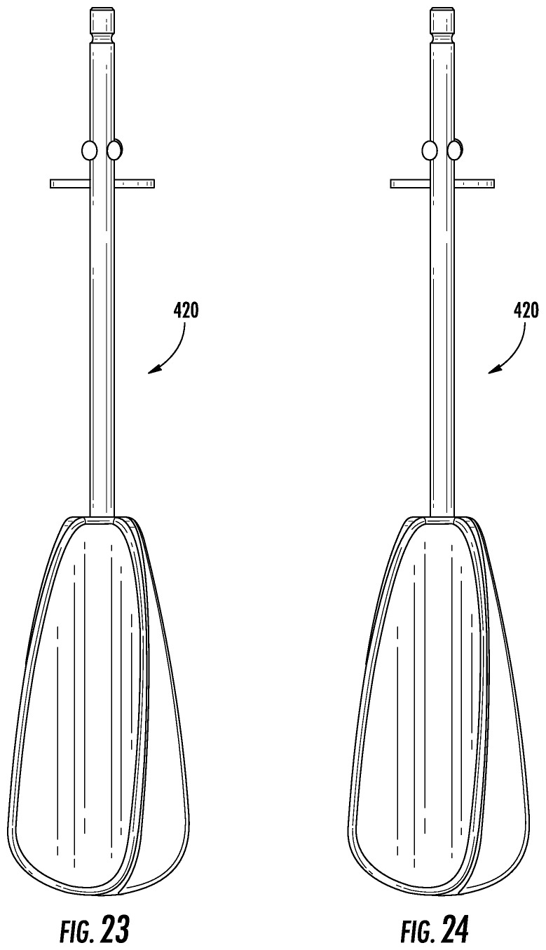

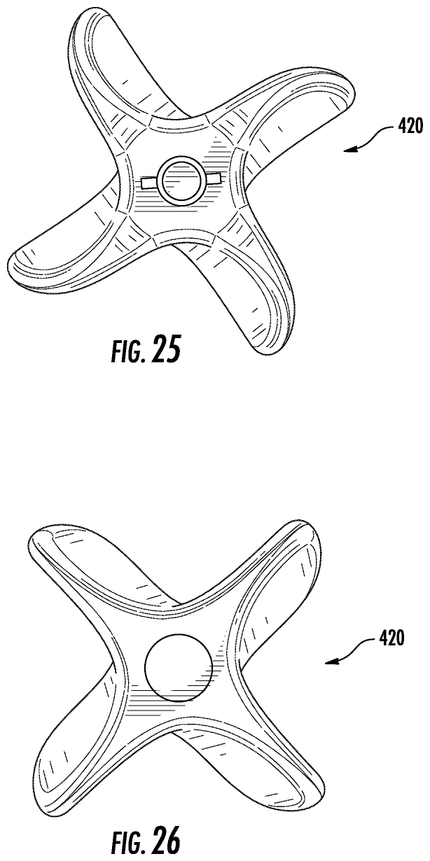

Also, although each of the beaters 20, 20′, 120, 120′, 220, 320 discussed above has three blades, in some embodiments more blades may be employed. As an example, FIGS. 20-26 illustrate beaters 420, 420′ that have four blades 426 each. Notably, the blade complexes 424, 424′ of the beaters 420, 420′ are identical, rather than being mirror images of each other, although in other embodiments the blade complexes 424, 424′ are mirror images of each other

If more than three blades are employed, the registry feature may be configured to ensure that the number of potential mounting orientations does not exceed the number of blades.

As a further example, the edges of the blades 26, 26′, 426 may be configured differently, with a wider or narrower arc length, more or less “twist” in the edge, greater or less overall length, or the like. Other variations may also be contemplated.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A beater for a mixer, comprising:
an elongate shaft that defines a longitudinal axis between first and second ends;
a blade complex including a central body and at least three blades, the central body attached to the first end of the shaft, the blades attached to and extending radially outwardly from the shaft, each of the blades including a partially helical radially-outward edge, each blade including a continuous surface devoid of openings between the body and the edge, the surface including a concave section.

2. The beater defined in claim 1, wherein the radially outward edge of each blade is configured such that, with increasing distance from an upper end thereof, a line tangent to the radially-outward edge defines an angle with the longitudinal axis that increases.

3. The beater defined in claim 2, wherein the radially outward edge of each blade is configured such that, over a major portion of the edge, the edge tapers outwardly from the longitudinal axis.

4. The beater defined in claim 1, wherein the at least three blades is three blades.

5. The beater defined in claim 4, further comprising a registration feature mounted to the shaft that is configured to allow the beater to be mounted to a mixer housing in one of only three orientations relative to the longitudinal axis.

6. The beater defined in claim 5, wherein the registration feature comprises a plurality of projections emanating from a central hub that are circumferentially equidistant from each other.

7. The beater defined in claim 4, wherein each of the radially-outward edges defines a circumferential arc of between about 30 and 75 degrees.

8. The beater defined in claim 1, wherein the blade complex is formed as a monolithic component.

9. The beater defined in claim 1, wherein the blade complex comprises a polymeric material.

10. The beater defined in claim 1, wherein the body includes a lower surface, and wherein the lower surface is non-concave.

11. The beater defined in claim 1, wherein each of the surface of the blades includes a convex section.

12. A mixer, comprising:
a housing containing a motor and first and second beater mounting locations; and
first and second beaters, each of the first and second beaters comprising:
an elongate shaft that defines a longitudinal axis between first and second ends;
a blade complex including a central body and at least three blades, the central body attached to the first end of the shaft, the blades attached to and extending radially outwardly from the shaft, each of the blades including a partially helical radially-outward edge, each blade including a continuous surface devoid of openings between the body and the radially-outward edge;
wherein the blade complex of the first beater is a mirror image of the blade complex of the second beater.

13. The mixer defined in claim 12, wherein the at least three blades is three blades.

14. The mixer defined in claim 13, further comprising, on each of the first and second beaters, a registration feature mounted to the shaft that is configured to allow each of the first and second beaters to be mounted to a respective one of the first and second mounting locations on the housing in one of only three orientations relative to the longitudinal axis.

15. The mixer defined in claim 14, wherein the registration feature comprises a plurality of projections emanating from a central hub that are circumferentially equidistant from each other.

16. The mixer defined in claim 12, wherein the first beater includes a mounting feature that prevents mounting of the first beater in the second mounting location.

17. The mixer defined in claim 12, wherein the housing contains a drive train configured to rotate the first beater in a first rotative direction and to rotate the second beater in a second, opposite rotative direction.

18. A mixer, comprising:
a housing containing a motor and first and second beater mounting locations; and
first and second beaters, each of the first and second beaters comprising:
an elongate shaft that defines a longitudinal axis between first and second ends;
a blade complex including a central body and four blades, the central body attached to the first end of the shaft, the blades attached to and extending radially outwardly from the shaft, each of the blades including a partially helical radially-outward edge, each blade including a continuous surface devoid of openings between the body and the radially-outward edge;
wherein the blade complex of the first beater is a mirror image of the blade complex of the second beater.

19. The mixer defined in claim 18, wherein the first beater includes a mounting feature that prevents mounting of the first beater in the second mounting location.
